(19) United States
(12) Patent Application Publication
(10) Pub. No.: US 2021/0053683 A1
(43) Pub. Date: Feb. 25, 2021

(54) VERTICAL-TAILLESS AIRCRAFT

(71) Applicant: KAWASAKI JUKOGYO KABUSHIKI KAISHA, Kobe-shi (JP)

(72) Inventors: Takuya FURUMOTO, Kakamigahara-shi (JP); Seiichi SONODA, Kakamigahara-shi (JP); Yoshiyuki SHIBATA, Kakamigahara-shi (JP); Hiroyoshi ASANO, Kakamigahara-shi (JP)

(73) Assignee: KAWASAKI JUKOGYO KABUSHIKI KAISHA, Kobe-shi (JP)

(21) Appl. No.: 17/092,553

(22) Filed: Nov. 9, 2020

Related U.S. Application Data
(63) Continuation of application No. PCT/JP2019/018422, filed on May 8, 2019.

(30) Foreign Application Priority Data
May 10, 2018 (JP) 2018-091662

(51) Int. Cl. B64C 39/10

(52) U.S. Cl. CPC B64C 39/10; B64C 2230/20; B64C 2039/105

(57) ABSTRACT

A vertical-tailless aircraft includes a body, a main wing, and a negative pressure generating portion. The body extends in a direction along an aircraft axis and includes a front body and a rear body. The main wing is provided on a side surface of the body. The negative pressure generating portion is provided at the rear body and is configured to generate negative pressure on the side surface of the rear body in a case that the vertical-tailless aircraft sideslips.

### CROSS-REFERENCE TO RELATED APPLICATIONS

The present application is a bypass continuation of and claims priority to PCT/JP2019/018422, filed on May 8, 2019, which claims priority to JP 2018-091662, filed May 10, 2018, both of which are incorporated by reference in their entirety.

### TECHNICAL FIELD

The present application relates to a vertical-tailless aircraft that is an aircraft without a vertical tail.

### BACKGROUND

Conventionally, a vertical-tailless airplane is known as an aircraft without a vertical tail. An airframe of the vertical-tailless airplane includes a left body portion and a right body portion. The left body portion diagonally projects from a side surface of a main body portion of the airframe toward a left, rear, and outer side, and the right body portion diagonally projects from the side surface of the main body portion of the airframe toward a right, rear, and outer side. Elevators are provided at rear end portions of the left and right body portions.

The conventional vertical-tailless airplane improves directional stability by utilizing a difference between the speed of air flow on an upper surface of the airframe and the speed of air flow on a lower surface of the airframe when the vertical-tailless airplane sideslips. Therefore, each of the upper and lower surfaces of the airframe needs to have a curved shape, and as a result, is expensive to manufacture.

### SUMMARY

In order to solve the above-described problems, a vertical-tailless aircraft according to one aspect of the present application includes a body, a main wing, and a negative pressure generating portion. The body extends in a direction along an aircraft axis and includes a front body and a rear body. The main wing is provided on a side surface of the body. The negative pressure generating portion is provided at the rear body and is configured to generate negative pressure on the side surface of the rear body in a case that the vertical-tailless aircraft sideslips.

### BRIEF DESCRIPTION OF THE DRAWINGS

FIG. 1 is a diagram showing a vertical-tailless aircraft when viewed from an upper side according to an embodiment of the present application.

FIG. 2 is a diagram showing the vertical-tailless aircraft of FIG. 1 when viewed from a left side.

FIG. 3 is a sectional view of the vertical-tailless aircraft taken along line A-A′ of FIG. 1.

FIG. 4 is a sectional view showing another exemplary implementation of the vertical-tailless aircraft.

FIGS. 5A and 5B are sectional views showing other exemplary implementations of the vertical-tailless aircraft.

FIGS. 6A and 6B are sectional views showing other exemplary implementations of the vertical-tailless aircraft.

### DETAILED DESCRIPTION OF THE DRAWINGS

A vertical-tailless aircraft according to one aspect includes a body, a main wing, and a negative pressure generating portion. The body extends in a direction along an aircraft axis and includes a front body and a rear body. The main wing is provided on a side surface of the body. The negative pressure generating portion is provided at the rear body and is configured to generate negative pressure on the side surface of the rear body in a case that the vertical-tailless aircraft sideslips.

According to this configuration, force acting in such a direction so as to reduce a deviation between the aircraft axis and a flight direction due to the sideslip is generated by the negative pressure generated on the side surface. Therefore, directional stability is improved while suppressing increases in cost.

In this vertical-tailless aircraft, the rear portion of the body may include a corner portion formed between a ceiling surface and the side surface or between a bottom surface and the side surface, and the negative pressure generating portion may be the corner portion. According to this configuration, air flow flowing along the end surface due to the sideslip separates at the corner portion. Thus, the negative pressure is efficiently generated on the side surface, and therefore, the directional stability can be improved. Furthermore, since the negative pressure generating portion is formed by providing the corner portion of the rear portion, the configuration can be simplified, and the cost increase can be suppressed.

In this vertical-tailless aircraft, an interior angle of the corner portion in a section of the rear portion of the body which section is perpendicular to the aircraft axis may be 60° or more and 150° or less. According to this configuration, the negative pressure is efficiently generated at the corner portion having such angle, and therefore, the directional stability can be improved.

In this vertical-tailless aircraft, the rear portion of the body may have a polygonal section that is perpendicular to the aircraft axis. According to this configuration, the negative pressure is efficiently generated at the negative pressure generating portion, and therefore, the directional stability can be improved. Furthermore, since the negative pressure generating portion is formed by the shape of the rear portion, the configuration can be simplified, and the cost increase can be suppressed.

In this vertical-tailless aircraft, the rear portion of the body may have such a shape that an area of a section of the rear portion which section is perpendicular to the aircraft axis decreases toward a rear side. According to this configuration, the negative pressure is more efficiently generated at the negative pressure generating portion, and therefore, the directional stability can be improved.

In this vertical-tailless aircraft, at least one of a ceiling surface and bottom surface of the rear portion of the body may be a flat surface. According to this configuration, since air flow flowing along the ceiling surface and/or the bottom surface as the flat surfaces easily separates at the corner portion, the directional stability can be improved by the generated negative pressure.

Hereinafter, embodiments of the present application will be described with reference to the drawings. In the following description and the drawings, the same reference signs are used for the same or corresponding components, and a repetition of the same explanation is avoided.

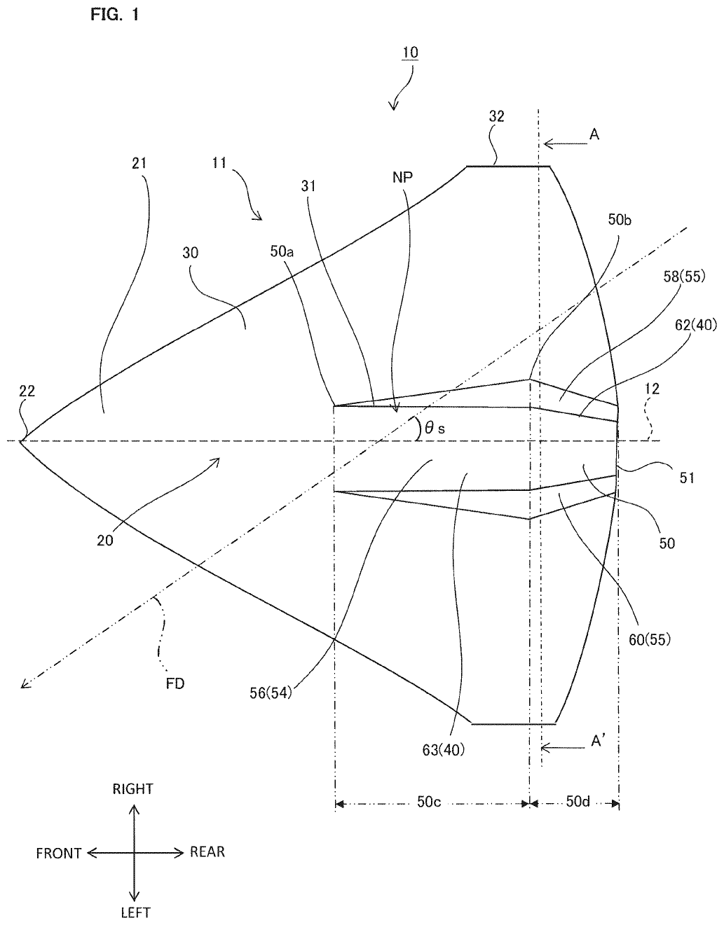

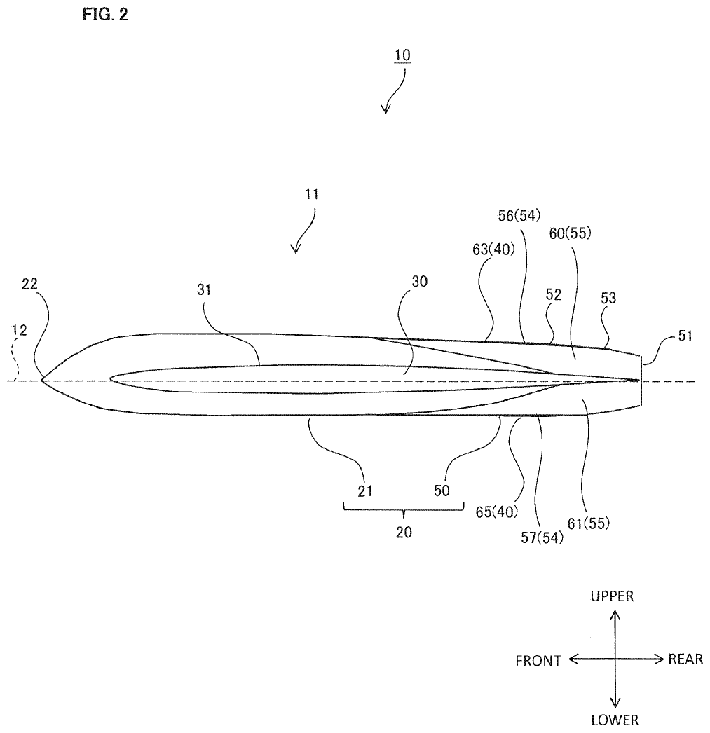

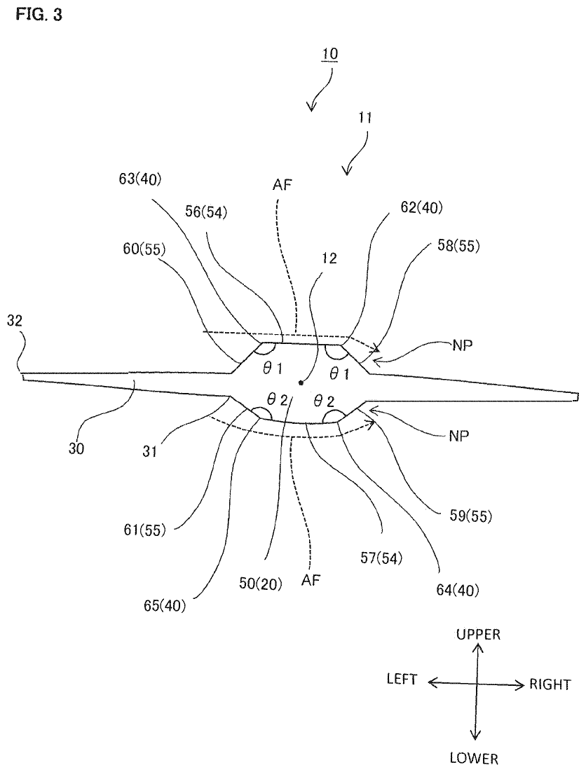

FIG. 1 shows a vertical-tailless aircraft when viewed from an upper side according to an embodiment of the present application. FIG. 2 shows the vertical-tailless aircraft of FIG. 1 when viewed from a left side. FIG. 3 is a sectional view of the vertical-tailless aircraft taken along line A-A′ of FIG. 1. As shown in FIGS. 1 to 3, a vertical-tailless aircraft 10 according to the present application is an airplane, such as a flying wing, which does not include any horizontal tails or vertical tails. The vertical-tailless aircraft 10 includes an airframe 11. The vertical-tailless aircraft 10 may include a power unit. It should be noted that the following will describe the vertical-tailless aircraft which does not include any horizontal tails. However, the vertical-tailless aircraft 10 may include the horizontal tails as long as it does not include the vertical tail.

The airframe 11 includes a body 20, a main wing 30, and negative pressure generating portions 40. It should be noted that a direction parallel to an aircraft axis 12 of the airframe 11 extending in a front-rear direction is referred to as an aircraft axis direction, and directions perpendicular to the aircraft axis direction are referred to as an upper-lower direction and a left-right direction. However, directions of the vertical-tailless aircraft 10 are not limited to these directions.

The body 20 has a substantially tubular shape and extends in the aircraft axis direction. The body 20 includes a front portion (front body 21) and a rear portion (rear body 50) in the aircraft axis direction. The size of the rear body 50 in the aircraft axis direction is at least 5% or more and 60% or less of the size of the body 20 in the aircraft axis direction, more preferably 20% or more and 50% or less of the size of the body 20 in the aircraft axis direction.

The front body 21 has a circular or oval section perpendicular to the aircraft axis 12 and is formed in a curved shape in a circumferential direction. The front body 21 is inclined in a curved shape in the aircraft axis direction such that an area of the section perpendicular to the aircraft axis 12 decreases toward a front side. A front end portion 22 of the front body 21 is closed.

The size of the rear body 50 in the upper-lower direction is, for example, 50% or more of the size of the body 20 in the upper-lower direction. The size of the rear body 50 in the upper-lower direction is shorter than the size of the rear body 50 in the left-right direction. However, the size of the rear body 50 in the upper-lower direction may be the same as or longer than the size of the rear body 50 in the left-right direction.

The rear body 50 is reduced in size such that the area of a section thereof perpendicular to the aircraft axis 12 decreases toward a rear side. A rear end portion 51 of the rear body 50 is open as a nozzle outlet of a jet engine that is the power unit of the vertical-tailless aircraft 10. In the aircraft axis direction, the size of a part of the rear body 50 which part is reduced in size toward the rear side is longer than the size of a part of the front body 21 which part is reduced in size toward the front side. For example, the entire rear body 50 is reduced in size toward the rear side. However, such size-reduction shape may be formed at a part of the rear body 50. Typically, the size-reduction shape is formed at a rear portion including the rear end portion 51 in the rear body 50.

In the present application, a ceiling surface 56 and a bottom surface 57 are linearly inclined in the aircraft axis direction such that the size of the rear body 50 in the upper-lower direction is reduced toward the rear side. An inclination angle of the rear body 50 in the aircraft axis direction changes at first rear portion 52 and second rear portion 53, and this inclination angle increases toward the rear side. The ceiling surface 56 and the bottom surface 57 may be inclined in a curved shape in the aircraft axis direction such that the size of the rear body 50 in the upper-lower direction is reduced toward the rear side. Moreover, the size of the rear body 50 in the left-right direction may be reduced toward the rear side such that the area of the section of the rear body 50 decreases toward the rear side.

The rear body 50 is reduced in size toward the rear side such that the size of the ceiling surface 56 in the left-right direction and the size of the bottom surface 57 in the left-right direction are reduced toward the rear side. For example, both ends of the ceiling surface 56 and both ends of the bottom surface 57 are linearly inclined with respect to the aircraft axis 12. This inclination angle changes at a predetermined portion 50b that is located rearwardly away from a front end 50a of the rear body 50 by a predetermined distance, the front end 50a being connected to the front body 21. In the rear body 50, the inclination angle of a rear portion 50d extending from the predetermined portion 50b to the rear end portion 51 is larger than the inclination angle of a front portion 50c extending from the front end 50a to the predetermined portion 50b. In the aircraft axis direction, the size of the front portion 50c is larger than the size of the rear portion 50d.

The rear body 50 has, for example, a polygonal section perpendicular to the aircraft axis 12. The rear body 50 includes end surfaces 54, side surfaces 55, and corner portions therebetween. In the present application, the rear body 50 has a hexagonal shape and includes two end surfaces 54 and four side surfaces 55. The two end surfaces 54 are the ceiling surface 56 and the bottom surface 57. The four side surfaces 55 are an upper-right side surface 58, a lower-right side surface 59, an upper-left side surface 60, and a lower-left side surface 61. The four side surfaces 55 connect the ceiling surface 56 and the bottom surface 57.

The bottom surface 57 is provided substantially parallel to the ceiling surface 56 and is arranged lower than the ceiling surface 56. In the present application, the ceiling surface 56 is a flat surface extending linearly in the left-right direction, and the bottom surface 57 is a curved surface extending in a curved shape in the left-right direction so as to be away from the aircraft axis 12. However, the ceiling surface 56 may be a curved surface. Moreover, the bottom surface 57 may be a flat surface. As long as the flat surface extends linearly in the left-right direction, the flat surface may curve in the aircraft axis direction or may be inclined linearly in the aircraft axis direction.

An upper end portion of the upper-right side surface 58 is connected to a right end portion of the ceiling surface 56, and a lower end portion of the upper-right side surface 58 is connected to an upper end portion of the lower-right side surface 59. A lower end portion of the lower-right side surface 59 is connected to a right end portion of the bottom surface 57. An upper end portion of the upper-left side surface 60 is connected to a left end portion of the ceiling surface 56, and a lower end portion of the upper-left side surface 60 is connected to an upper end portion of the lower-left side surface 61. A lower end portion of the lower-left side surface 61 is connected to a left end portion of the bottom surface 57.

The upper-right side surface 58 and the upper-left side surface 60 are symmetrical about a line passing through the aircraft axis 12 and extending in the upper-lower direction. Moreover, the lower-right side surface 59 and the lower-left side surface 61 are also symmetrical about the line. Each of the side surfaces 55 is a flat surface extending linearly in a predetermined direction perpendicular to the aircraft axis 12. Each of the side surfaces 55 may curve in the aircraft axis direction or may be inclined linearly in the aircraft axis direction.

Each of the upper-right side surface 58 and the upper-left side surface 60 has such a shape that the size between an end connected to the ceiling surface 56 and its end connected to the main wing 30 increases toward the rear side in the front portion 50c of the rear body 50 and decreases toward the rear side in the rear portion 50d of the rear body 50. Each of the lower-right side surface 59 and the lower-left side surface 61 has such a shape that the size between its end connected to the bottom surface 57 and its end connected to the main wing 30 increases toward the rear side in the front portion 50c of the rear body 50 and decreases toward the rear side in the rear portion 50d of the rear body 50.

The corner portions include an upper-right corner portion 62 between the upper-right side surface 58 and the ceiling surface 56, an upper-left corner portion 63 between the upper-left side surface 60 and the ceiling surface 56, a lower-right corner portion 64 between the lower-right side surface 59 and the bottom surface 57, and a lower-left corner portion 65 between the lower-left side surface 61 and the bottom surface 57. Each of an angle θ1 of the upper-right corner portion 62, the angle θ1 of the upper-left corner portion 63, an angle θ2 of the lower-right corner portion 64, and the angle θ2 of the lower-left corner portion 65 is 150° or less. In order to generate negative pressure, each of the angles θ1 and θ2 is more preferably 90° or more and 150° or less. The angle of the corner portion denotes an interior angle of the corner portion in a section of the rear body 50 which section is perpendicular to the aircraft axis 12.

The main wing 30 is provided at the side surfaces 55 of the body 20 and extends from the body 20 linearly in the left-right direction. The main wing 30 has such a shape that the size in the left-right direction increases toward the rear side. The main wing 30 is, for example, a delta wing having a substantially triangular shape. The main wing 30 includes a wing root 31 and a wing tip 32. The wing root 31 is connected to the body 20. The wing tip 32 is located furthest away from the wing root 31 in the left-right direction. However, the main wing 30 is not limited to the delta wing.

A front edge of a part of the main wing 30 which part is located between the front end portion 22 and the wing tip 32 is inclined substantially linearly so as to be away from the wing root 31 as it extends toward the rear side in the aircraft axis direction. The wing tip 32 extends linearly in the aircraft axis direction from a predetermined position of the rear body 50. A rear end of the main wing 30 is formed in a curved shape such that the size of the main wing 30 in the aircraft axis direction increases from the wing tip 32 toward the wing root 31.

The wing root 31 is provided from the front body 21 to the rear end of the rear body 50 and extends in the aircraft axis direction. In the present application, the wing root 31 is arranged between the upper-right side surface 58 and the lower-right side surface 59 in the upper-lower direction and between the upper-left side surface 60 and the lower-left side surface 61 in the upper-lower direction.

Each of the negative pressure generating portions 40 is a portion where negative pressure NP is generated on the side surface 55 of the rear body 50 at the time of sideslip. For example, the negative pressure generating portions 40 are constituted by the corner portions of the rear body 50. Each of the corner portions constituting the negative pressure generating portions 40 is provided behind the center of gravity of the airframe 11, and the size of each corner portion in the aircraft axis direction is at least 5% or more and 60% or less of the size of the body 20 in the aircraft axis direction, more preferably 20% or more and 50% or less of the size of the body 20 in the aircraft axis direction.

For example, in a sideslip state in which a flight direction FD of the vertical-tailless aircraft 10 and the aircraft axis 12 do not coincide with each other, a sideslip angle θs is generated between the flight direction FD and the aircraft axis 12. In this case, air flow AF flows toward the body 20 in a direction opposite to the flight direction FD.

The air flow AF shown by a dotted line in FIG. 3 flows along the ceiling surface 56 in a direction intersecting with the aircraft axis 12 and separates at the upper-right corner portion 62. With this, the negative pressure NP is generated on the upper-right side surface 58 connected to the ceiling surface 56 through the upper-right corner portion 62. Similarly, the air flow AF flows along the bottom surface 57 in a direction intersecting with the aircraft axis 12 and separates at the lower-right corner portion 64. With this, the negative pressure NP is generated on the lower-right side surface 59 connected to the bottom surface 57 through the lower-right corner portion 64.

As shown in FIG. 1, the negative pressure NP is generated on the side surface 55 which is located at a side that is the same as a side toward which a nose (front end portion 22) is directed with respect to the flight direction FD, the side surface 55 being located downstream of the aircraft axis 12 in a direction along the air flow AF. Force of directing the direction of the aircraft axis 12 toward the direction along the air flow AF is generated by the negative pressure NP. Therefore, the sideslip angle θs decreases, and the direction of the aircraft axis 12 changes to approach the flight direction FD. Thus, yawing is controlled, and therefore, directional stability can be improved.

According to the above discussion, since the vertical-tailless aircraft 10 is not provided with a tail, a reduction in air resistance during flight, a reduction in weight, and a cost reduction by a reduction in the number of parts can be realized.

Moreover, a decrease in the directional stability by the absence of the tail can be reduced by the negative pressure generated by the negative pressure generating portions 40. Furthermore, since the side surfaces 55 and the ceiling surface 56 are formed as the flat surfaces, the negative pressure NP is easily generated, and therefore, the decrease in the directional stability can be further reduced.

In addition, since each of the angles θ1 and θ2 of the corner portions constituting the negative pressure generating portions 40 is 150° or less, the negative pressure NP is easily generated, and the decrease in the directional stability can be further reduced. Furthermore, since a plurality of negative pressure generating portions 40 are provided at the rear body 50 by the four corner portions, the decrease in the directional stability can be further reduced.

The size of the rear body 50 in the left-right direction is reduced toward the rear side such that the area of the section of the rear body 50 which section is perpendicular to the aircraft axis 12 decreases toward the rear side. Therefore, the negative pressure is generated more efficiently. Furthermore, since the size of the rear body 50 in the left-right direction is reduced toward the rear side, a region where the negative pressure is generated increases, and therefore, the decrease in the directional stability can be further reduced.

The side surfaces 55 and the ceiling surface 56 located adjacent to the negative pressure generating portions 40 which improve the directional stability are constituted by the flat surfaces, and this excels in manufacturability more than when these surfaces 55 and 56 are constituted by curved surfaces.

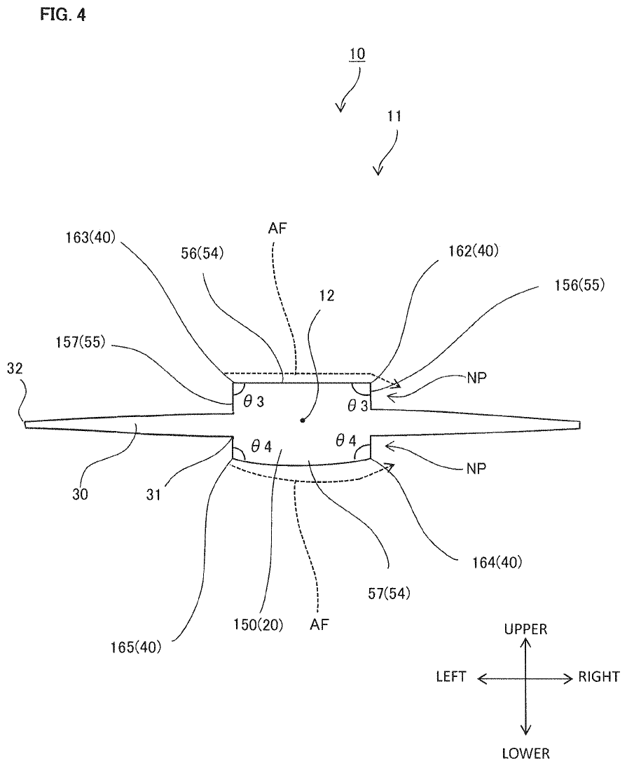

FIG. 4 illustrates a sectional view of another exemplary implementation of the vertical-tailless aircraft. As shown in FIG. 4, a section of a rear body 150 which section is perpendicular to the aircraft axis 12 may have a quadrangular shape. In this case, the rear body 150 includes the end surfaces 54, the side surfaces 55, and the corner portions therebetween. The end surfaces 54 include the ceiling surface 56 and the bottom surface 57. The side surfaces 55 include a right side surface 156 and a left side surface 157.

Regarding the upper-lower direction, an upper end portion of the right side surface 156 is connected to a right end portion of the ceiling surface 56, and a lower end portion of the right side surface 156 is connected to a right end portion of the bottom surface 57. An upper end portion of the left side surface 157 is connected to a left end portion of the ceiling surface 56, and a lower end portion of the left side surface 157 is connected to a left end portion of the bottom surface 57. The wing root 31 is provided at of a center of the right side surface 156 in the upper-lower direction and a center of the left side surface 157 in the upper-lower direction.

The corner portions include an upper-right corner portion 162 between the right side surface 156 and the ceiling surface 56, an upper-left corner portion 163 between the left side surface 157 and the ceiling surface 56, a lower-right corner portion 164 between the right side surface 156 and the bottom surface 57, and a lower-left corner portion 165 between the left side surface 157 and the bottom surface 57. Each of an angle θ3 of the upper-right corner portion 162, the angle θ3 of the upper-left corner portion 163, an angle θ4 of the lower-right corner portion 164, and the angle θ4 of the lower-left corner portion 165 is 90°.

The ceiling surface 56 is a flat surface extending linearly in the left-right direction. The right side surface 156 and the left side surface 157 are flat surfaces extending linearly in the upper-lower direction. The bottom surface 57 is a curved surface extending in a curved shape in the left-right direction. At least one of the ceiling surface 56, the right side surface 156, and the left side surface 157 may be a curved surface. Moreover, the bottom surface 57 may be a flat surface. The directional stability by the negative pressure generating portions 40 when these surfaces are constituted by flat surfaces is more excellent than the directional stability by the negative pressure generating portions 40 when these surfaces are constituted by curved surfaces.

The negative pressure generating portions 40 are constituted by the upper-right corner portion 162, the upper-left corner portion 163, the lower-right corner portion 164, and the lower-left corner portion 165. For example, when the upper-right corner portion 162 and the lower-right corner portion 164 are located at a downstream side in a direction along the air flow AF, the negative pressure NP is generated on the right side surface 156. In contrast, when the upper-left corner portion 163 and the lower-left corner portion 165 are located at a downstream side in the direction along the air flow AF, the negative pressure NP is generated on the left side surface 157. With this, the directional stability can be improved.

The area of a section of the rear body 150 which section is perpendicular to the aircraft axis 12 does not change in the aircraft axis direction, i.e., is constant in the aircraft axis direction. Even in this case, the decrease in the directional stability by the absence of the tail can be reduced. The rear body 150 may be reduced in size such that: the size in at least one of the upper-lower direction and the left-right direction decreases toward the rear side; and the area of the section perpendicular to the aircraft axis 12 decreases toward the rear side.

The above implementations have described the rear bodies 50 and 150 in each of which the section perpendicular to the aircraft axis 12 is a polygonal shape, i.e., a hexagonal shape or a quadrangular shape. However, the shapes of the rear bodies 50 and 150 are not limited to these.

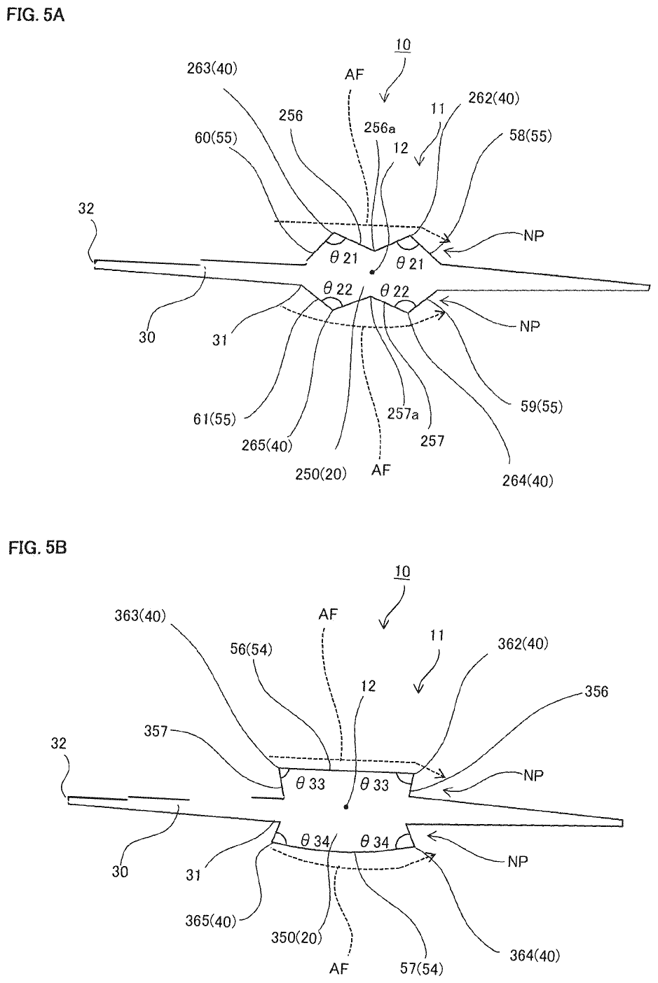

For example, as shown in FIG. 5A, the section perpendicular to the aircraft axis 12 may have such a polygonal shape that regarding the hexagonal section perpendicular to the aircraft axis 12 in FIG. 3, a ceiling surface 256 and bottom surface 257 of a rear body 250 are depressed toward the aircraft axis 12. For example, the ceiling surface 256 has such a shape as to be bent at a bent portion 256a to form two flat surfaces, and the bottom surface 257 has such a shape as to be bent at a bent portion 257a to form two flat surfaces. In this case, a corner portion 262 between the ceiling surface 256 and the side surface 58-61, a corner portion 263 between the ceiling surface 256 and the side surface 55, a corner portion 264 between the bottom surface 257 and the side surface 55, and a corner portion 265 between the bottom surface 257 and the side surface 55 constitute the negative pressure generating portions 40. Each of angles θ21 and θ22 of the corner portions 262, 263, 264, and 265 is 60° or more and 150° or less.

For example, as shown in FIG. 5B, the section perpendicular to the aircraft axis 12 may have such a polygonal shape that regarding the quadrangular section perpendicular to the aircraft axis 12 in FIG. 4, side surfaces 356 and 357 of a rear body 350 are depressed toward the aircraft axis 12. In this case, a corner portion 362 between the ceiling surface 56 and the side surface 356, a corner portion 363 between the ceiling surface 56 and the side surface 357, a corner portion 364 between the bottom surface 57 and the side surface 356, and a corner portion 365 between the bottom surface 57 and the side surface 357 constitute the negative pressure generating portions 40. Each of angles θ33 and θ34 of the corner portions 362, 363, 364, and 365 is 60° or more and 90° or less.

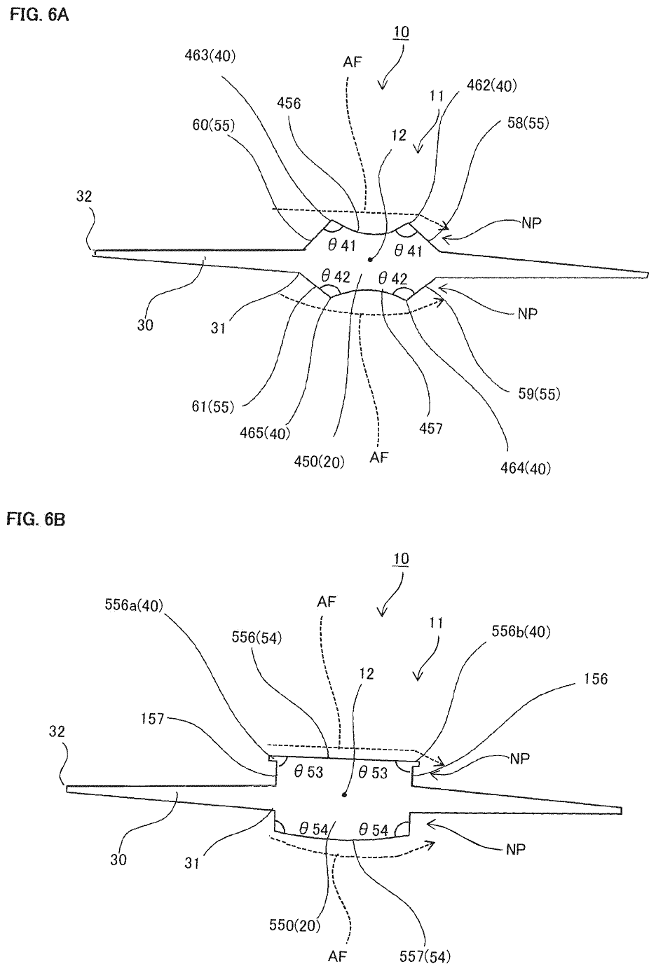

As shown in FIG. 6A, part of a polygonal section of a rear body 450 which section is perpendicular to the aircraft axis 12 may have a curved shape. For example, a ceiling surface 456 is formed by a curved surface that curves so as to be depressed toward the aircraft axis 12, and a bottom surface 457 is formed by a curved surface that curves so as to be depressed toward the aircraft axis 12. In this case, a corner portion 462 between the ceiling surface 456 and the side surface 58-61, a corner portion 463 between the ceiling surface 456 and the side surface 55, a corner portion 464 between the bottom surface 457 and the side surface 55, and a corner portion 465 between the bottom surface 457 and the side surface 55 constitute the negative pressure generating portions 40. Each of angles θ41 and θ42 of the corner portions 462, 463, 464, and 465 is 60° or more and 150° or less.

In the above discussion, the corner portions of the rear body 50 formed in a polygonal shape constitute the negative pressure generating portions 40. However, the present application is not limited to this. The other configuration may be adopted as long as the negative pressure is generated on the side surface located at a side toward which the nose is directed in the rear body 50 when the airframe 11 sideslips. For example, as shown in FIG. 6B, the side surfaces 156 and 157 of a rear body 550 may be depressed toward the aircraft axis 12, and left and right end portions 556a and 556b of a ceiling surface 556 may be formed so as to project in a lateral direction beyond the corresponding side surfaces 156 and 157. These end portions 556a and 556b constitute the negative pressure generating portions 40. As with the ceiling surface 556, left and right end portions of a bottom surface 557 may be formed so as to project in the lateral direction beyond the corresponding side surfaces 156 and 157 and may constitute the negative pressure generating portions 40. The direction in which the end portions 556a and 556b project is not limited to the lateral direction and may be an upper direction, or upper-left and upper-right oblique directions.

The above embodiments may be combined with each other as long as they do not exclude each other. The foregoing explanation should be interpreted only as an example and is provided for the purpose of teaching the best mode for carrying out the present application to one skilled in the art. The structures and/or functional details may be substantially modified within the scope of the present application.

The vertical-tailless aircraft of the present application improves directional stability while also reducing manufacturing cost.

### REFERENCE SIGNS LIST

NP negative pressure
FD flight direction
AF airflow
10 vertical-tailless aircraft
11 airframe
12 aircraft axis
20 body
21 front body
22 front end portion
30 main wing
31 wing root
32 wing tip
40 negative pressure generating portion
50 rear body
50a front end
50b predetermined portion
50c front portion
50d rear portion
51 rear end portion
52 first rear portion
53 second rear portion
54 end surface
55 side surface
56 ceiling surface
57 bottom surface
58 upper-right side surface
59 lower-right side surface
60 upper-left side surface
61 lower-left side surface
62 upper-right corner portion
63 upper-left corner portion
64 lower-right corner portion
65 lower-left corner portion
150 rear body
156 right side surface
157 left side surface
162 upper-right corner portion
163 upper-left corner portion
164 lower-right corner portion
165 lower-left corner portion
250 rear body
256 ceiling surface
256a bent portion
257 bottom surface
257a bent portion
262 upper-right corner portion
263 upper-left corner portion
264 lower-right corner portion
265 lower-left corner portion
350 rear body
356 right side surface
357 left side surface
362 upper-right corner portion
363 upper-left corner portion
364 lower-right corner portion
365 lower-left corner portion
450 rear body
456 ceiling surface
457 bottom surface
462 upper-right corner portion
463 upper-left corner portion
464 lower-right corner portion
465 lower-left corner portion
550 rear body
556 ceiling surface
556a end portion
556b end portion
557 bottom surface

1. A vertical-tailless aircraft, comprising:
a body extending in a direction along an aircraft axis and including a front body and a rear body;
a main wing provided on a side surface of the body; and
a negative pressure generating portion provided at the rear body, the negative pressure generating portion configured to generate negative pressure on the side surface of the rear body in a case that the vertical-tailless aircraft sideslips.

2. The vertical-tailless aircraft according to claim 1, wherein
the negative pressure generating portion is a corner portion formed between a ceiling surface and the side surface or between a bottom surface and the side surface.

3. The vertical-tailless aircraft according to claim 2, wherein the ceiling surface includes an end portion that extends beyond the side surface.

4. The vertical-tailless aircraft according to claim 2, wherein an interior angle of the corner portion in a section of the rear body, which is perpendicular to the aircraft axis, is 60° or more and 150° or less.

5. The vertical-tailless aircraft according to claim 4, wherein the interior angle of the corner portion is 60° or more and 90° or less.

6. The vertical-tailless aircraft according to claim 1, wherein the rear body has a polygonal section perpendicular to the aircraft axis.

7. The vertical-tailless aircraft according to claim 1, wherein the rear body includes a ceiling surface and a bottom surface, each of which being a curved surface.

8. The vertical-tailless aircraft according to claim 7, wherein the ceiling surface and the bottom surface are curved so as to be depressed towards the aircraft axis.

9. The vertical-tailless aircraft according to claim 1, wherein the rear body in a left-right direction is reduced toward a rear side such that an area of a section of the rear body which is perpendicular to the aircraft axis decreases toward the rear side.

10. The vertical-tailless aircraft according to claim 1, wherein at least one of a ceiling surface and bottom surface of the rear body is a flat surface.

11. A vertical-tailless aircraft, comprising:
a body extending in a direction along an aircraft axis, the body including at least a ceiling surface, a side surface and a bottom surface;
a main wing provided on the side surface; and
a negative pressure generating portion that includes an upper corner portion and a lower corner portion, wherein
the upper corner portion is formed between the ceiling surface and the side surface,
the lower corner portion is formed between the bottom surface and the side surface, and
the negative pressure generating portion is configured to generate a negative pressure on the side surface of the body in a case that the vertical-tailless aircraft sideslips.

12. The vertical-tailless aircraft according to claim 11, wherein the ceiling surface includes an end portion that extends beyond the side surface.

13. The vertical-tailless aircraft according to claim 11, wherein interior angles of the upper corner portion and the lower corner portion in a section of the body, which is perpendicular to the aircraft axis, are 60° or more and 150° or less.

14. The vertical-tailless aircraft according to claim 13, wherein the interior angles of the upper corner portion and the lower corner portion are 60° or more and 90° or less.

15. The vertical-tailless aircraft according to claim 11, wherein each of the ceiling surface and the bottom surface is a curved surface.

16. The vertical-tailless aircraft according to claim 15, wherein the ceiling surface and the bottom surface are curved so as to be depressed towards the aircraft axis.

17. The vertical-tailless aircraft according to claim 11, wherein
the body includes a front body and a rear body, and
the rear body has a polygonal section perpendicular to the aircraft axis.

18. The vertical-tailless aircraft according to claim 17, wherein the rear body in a left-right direction is reduced toward a rear side such that an area of a section of the rear body which is perpendicular to the aircraft axis decreases toward the rear side.

19. The vertical-tailless aircraft according to claim 17, wherein
the rear body includes the ceiling surface and the bottom surface, and
at least one of the ceiling surface and the bottom surface is a flat surface.

20. A vertical-tailless aircraft, comprising:
an aircraft body extending in a direction along an aircraft axis, the aircraft body including at least a ceiling surface, a side surface and a bottom surface;
a main wing provided on the side surface;
an upper corner portion between the ceiling surface and the side surface; and
a lower corner portion between the bottom surface and the side surface, wherein
the upper corner portion and the lower corner portion are configured to generate a negative pressure on the side surface of the aircraft body in a case that the vertical-tailless aircraft sideslips.
